(19) United States
(12) Patent Application Publication
(10) Pub. No.: US 2005/0187987 A1
(43) Pub. Date: Aug. 25, 2005

(54) Managing transaction log data

(76) Inventor: Keng Leng Albert Lim, Tampines (SG)

Correspondence Address: HARNESS, DICKEY & PIERCE, P.L.C., P.O. BOX 828, BLOOMFIELD HILLS, MI, 48303, US

(21) Appl. No.: 11/051,802

(22) Filed: Feb. 4, 2005

(30) Foreign Application Priority Data
Feb. 25, 2004 (SG) 200401487-4

(51) Int. Cl. G06F 17/30

(52) U.S. Cl. 707/202

(57) ABSTRACT

An decoder module for normalizing log records generated by a computer system is provided. Based on a plurality of instruction sets stored in a database, the decoder module scans the log records and outputs the scanned results in a normalized format. A computer system for receiving a batch of log records from a plurality of remote computer systems, is able to process and normalize the log records using the decoder module.

### FIELD OF THE INVENTION

The present invention relates to log data managing systems. More particularly, the present invention relates to a universal managing transaction log data system for different log formats.

### BACKGROUND

Many computer systems generate transaction logs to record the events or tasks executed or performed by the system. For example, network terminals installed with accounting software for use with a banking mainframes, or the like, generate transaction logs and/or audit trails. Such transaction logs and/or audit trails are known collectively as data logs.

Data logs are generally in a format specifically programmed or designed for a particular system. This has resulted in the format of a data log for one device or software to vary from the format of other systems. In particular, the data log parameters such as length, size, definition, and the like are generally differ from one another.

The data logs of such a system may contain useful information. For example, data logs may be used to identify unauthorized transactions, security breaches, track past trends, predict future trends, etc.

As a computer network may have a vast number of different devices and software, such as servers, desktops, networks switches, telecommunication equipment, and the like, extracting useful information from the vast number of disparate data logs is difficult.

As such, to extract useful information from log records generated by different systems in different formats manually is rather time consuming. Further, for system which generates batches of log records, it is humanly impossible to extract information from the batches log records manually as a daily routine.

Therefore, a need exists for one system for normalizing/summarizing each of the log records generated by different system in a different format automatically, in an user preferred format.

### SUMMARY

It is an object of the present invention to provide a module, which preferably overcomes or at least partially alleviates drawbacks with existing systems.

According to one aspect of the present invention, there is provided a data decoding method for processing a log record of transaction in a computer system comprising the steps of loading an instruction set from a database; extracting information from the log record based on a plurality of syntaxes defined in the instruction set; and outputting a normalized output of an extracted information of the log record.

According to an alternative aspect of the present invention, there is provided a decoder module for processing a log record of transaction in a computer system comprising a decoder for outputting a normalized output; and a database having a plurality of instruction sets accessible by the decoder, for which each of the instruction sets comprising a format information of the log record, wherein the decoder is operable to load one of the instruction sets matches the corresponding log record and to extract information base on a plurality of syntaxes defined in the matched instruction set.

According to a further alternative aspect of the present invention, there is provided an information processing system comprising an information processing unit; a memory in response to the information processing unit for processing information; a decoder module installed in the information processing system for outputting a normalized output; a database having a plurality of instruction sets accessible by the decoder, for which each of the instruction sets comprising a format information of the log record, wherein the decoder is operable to load one of the instruction sets matches the corresponding log record and to extract information base on a plurality of syntaxes defined in the matched instruction set.

### BRIEF DESCRIPTION OF DRAWINGS

Further features of embodiments of the present invention will be readily apparent from the following detailed description of a non-limiting example, with reference to the accompanying drawings, in which:—

FIG. 1 is a schematic block diagram of a world-wide computer network having a network security service provider connected to the network;

FIG. 2 is a block diagram of a decoder module;

FIG. 3 is a flow diagram showing operation of the decoder module of FIG. 2 parsing an event alert;

FIG. 4 is a flow diagram showing an example of the operation of an event source validation of FIG. 3;

FIG. 5 is a flow diagram showing an example of process parsing rules of FIG. 4; and

FIG. 6 is a flow diagram showing an example of the operation of a scanning event alert of FIG. 5

Where the same reference numeral appears in more than one of the accompanying drawings, it is used to denote the same element.

### DETAILED DESCRIPTION

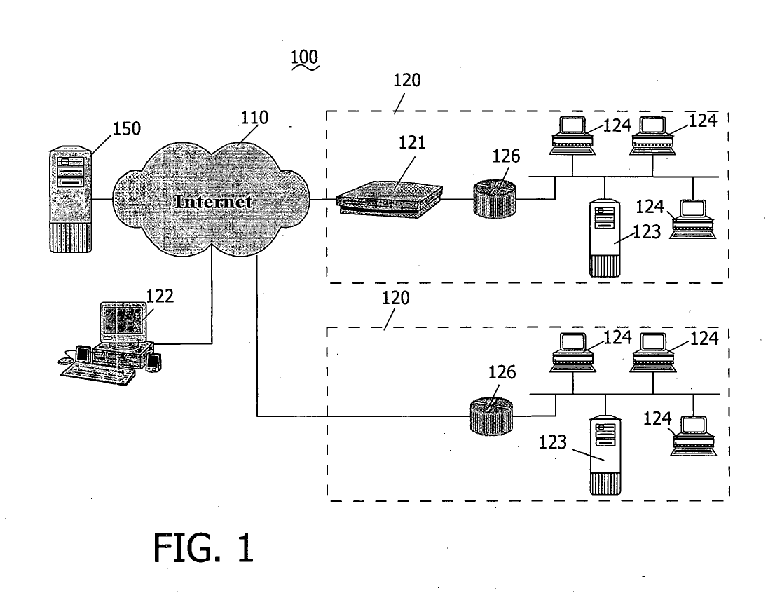

Referring to FIG. 1, there is shown a world-wide network 100 having a plurality of networks 120, such as local area networks (LAN), wide area network (WAN) or the like, and personal computers 122 connected with each other via the internet 110. The world-wide network 100 further includes a network security service provider (NSSP) 150, for which the NSSP 150 provides network security management services for any of the networks 120 or personal computers 122 that subscribed to the network security management services.

Typically, a network 120 includes a plurality of workstations 124 hosted by at least one server 123. Each of the workstations 124 and server 123 are inter-connected to each other via network switches 126, such as routers or the like. Some networks 120 may further be connected to a network gateway 121, such as an intruder detection system (IDS) or a Firewall firmware, to control and/or monitor transactions between the networks 120 and the internet 110. To keep track of the network transactions, the networks 120 generate a large number of logs or log records for further inspection by the network administrators whenever necessary. The logs or log records may be different in format depending on the networks 120.

For those networks 120 subscribed to the network security management services, the NSSP 120 often requires those logs or log records from the networks 120 for inspection purposes. The logs or log records sent to the NSSP 150 as information packages are hereinafter referred to as event alerts 170.

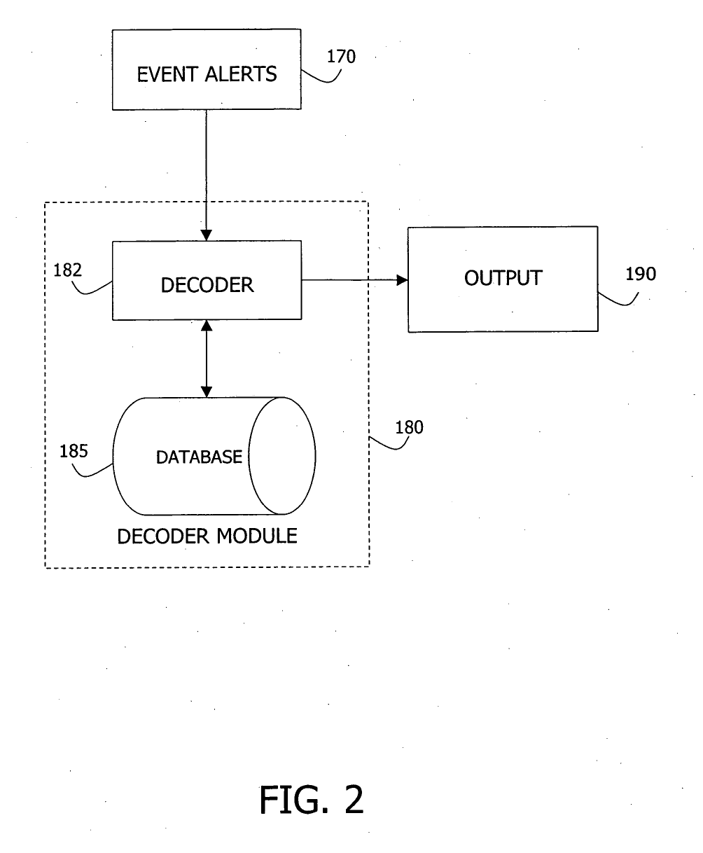

In operation, the NSSP 150 having a decoder module 180 receives batches of event alerts 170 from the networks 120 in real time as shown in FIG. 2. In a real time operation, the network 120 send out a event alert 170 to the NSSP 150 once it is generated, and the decoder module 180 parses the event alert 170 with no or substantially no delays. Such event alerts 180 may be sent via any of the available data transfer protocols, for example, transmission control protocol (TCP), user datagram protocol (UDP), simple mail transfer protocol (SMTP), simple network management protocol (SNMP), SYSLOG or the like. Based on the type of transmission protocol, the event alerts 170 may further vary in transmission formats. A database 185 for storing information regarding the type of protocols and data formats is accessible by a decoder 182 of the decoder module 180 for parsing the event alerts 170. The database 185 is configured to have a plurality of instruction sets, each defines a data format that is sent via a particular data transfer protocol. The database is editable to the user for adding, deleting and/or modifying whenever necessary. Once the event alert 170 is parsed, a normalized output will be sent to an output depository for inspection.

Table 1 illustrates an example of the instruction set:

TABLE 1
An Event Alert Sent By A Checkpoint Firewall via SMTP

| [CheckPoint Firewall-1 (FIREWALL) : SMTP : FW1&] | | |
|---|---|---|
| AttachDate | P | “ ” 1 <DDMMMCCYY> |
| AttackTime | P | “ ” 1 “ ” 2 <hh:mm:ss> |
| AttackType | K | “proto” “ ” |
| SourceIP | K | “src” “ ” |
| TargetIP | K | “dst” “ ” |
| TargetPort | K | “service” “ ” |
| SourcePort | K | “s_port” “ ” |

Each of the instruction sets is configured with a function header, quoted by square brackets “[. . . ]” or the like, for identifying the transmission source of the event alerts 170. For the above instance, the function header has the following parameters:
[<Device Type Name>:<Alert Type>:<Device Type Code>:<Keywords>]

where each of the parameters may be delimited by a colon “:” or the like and the parameters are described in TABLE 2 below.

TABLE 2

| Parameters | Description | Valid Value |
|---|---|---|
| Device Type Name | The name of the device | Alphanumeric |
| | type | e.g. |
| | Note: | Cyclops IDS |
| | When “FIREWALL” is | Checkpoint |
| | added in the decoder | Firewall |
| | display name, the | (FIREWALL) |
| | AttackType of the alert | |
| | will be in the following | |
| | format: | |
| | Firewall Alert | |
| | (<protocol>)− | |
| | <TargetPort> | |
| Alert Type | To indicate how the event | e.g. |
| | alert is being received by | TCP |
| | the decoder module. | UDP |
| | | SMTP |
| | | SNMP |
| | | SYSLOG |
| Device Type Code | The unique 3-letter device | Alphabetical letters |
| | type code that can be | e.g. |
| | assign by the user. | CYC |
| | (What is the main purpose | WGD |
| | for this field?) | FW1 |
| Keyword | Keyword can be used to | Alphanumeric |
| | trap for required alerts. | e.g. |
| | E.g. if the parsing is for | %PIX |
| | Cisco Pix alerts, only | |
| | alerts with the keyword | |
| | “PIX” will be parsed. | |
| | Keyword is not needed for | |
| | SMTP alert type. | |

The instruction sets further defining a function body having a plurality of syntaxes for describing at least parameters of outputs and output locations in which allow the decoder 182 extracts outputs from the event alerts 180. An example of the syntax's format is:
<TIF field><extraction method><extraction syntax>
<date-time format><value substitution>

The transportable incident format (TIF) field defining intended fields to be outputted in accordance with the user preference. In Example 1, for example, the TIF fields are AttackDate, AttackTime, AttackType, SourceIP, TargetIP, TargetName, TargetPort and SourcePort. Preceded by the TIF field, an extraction method incorporating an extraction syntax further described how the decoder 182 may extract the output. The extraction method may be defined by a simple one or two letter code, such as P for position parsing, K for keyword parsing, KP for position parsing or the like. Based on the extraction method, the extraction syntax further specifies where the decoder 182 may extract the corresponding output from the event alert 170. If the extracted value is a date or a time, the format of the user choice may be preset in the <date-time format>. If a desired value is intended in replace of an extracted value, <value substitution> may be used. The syntax is described in details in conjunction with the accompanying drawings hereinafter.

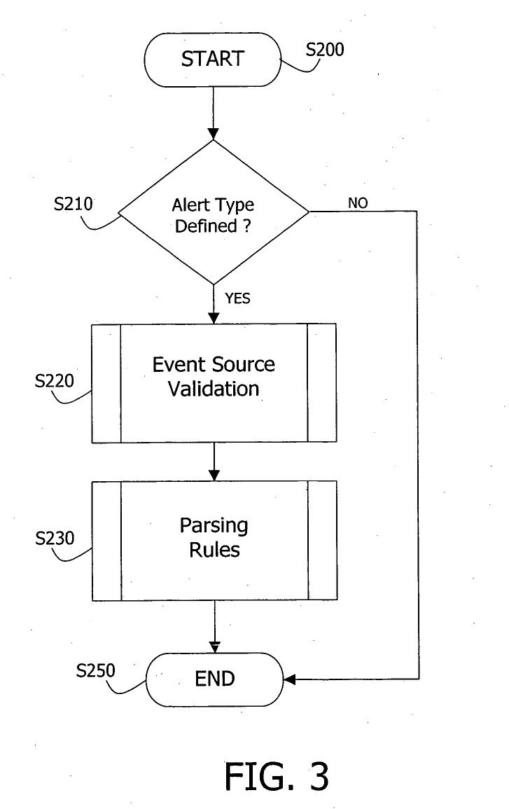

Operation of the decoder module 180 decoding an event alert 170 is illustrated in a flow diagram in FIG. 3. At start (step S200) if the NSSP 150 receives an event alert 170 from a transmission source, the decoder module 180 extracts an event type defined in the event alert 170 (step S210). The event type may be a Check-point 1 SMTP alert, a Watchguard STMP alert, a Check point-1 SNMP alert or the like. If the event type of the event alert 170 is not defined or known to the decoder module 180, the event alert 170 may be discarded and processing proceeds to step S250. The decoding process for the event alert 170 terminates (step S250) and the decoder module 180 may start decoding the next incoming event alert.

According to an alternative embodiment, the unknown event alert may be sent to the network administrator of the NSSP 150 for manual editing.

If the event type is defined, the decoder module 180 validates the event source (step S220) to obtain a device ID of the event source after the event type is being identified. A process of parsing the event alert (step S230) is performed to parse the event alert 170 into a prescribed format.

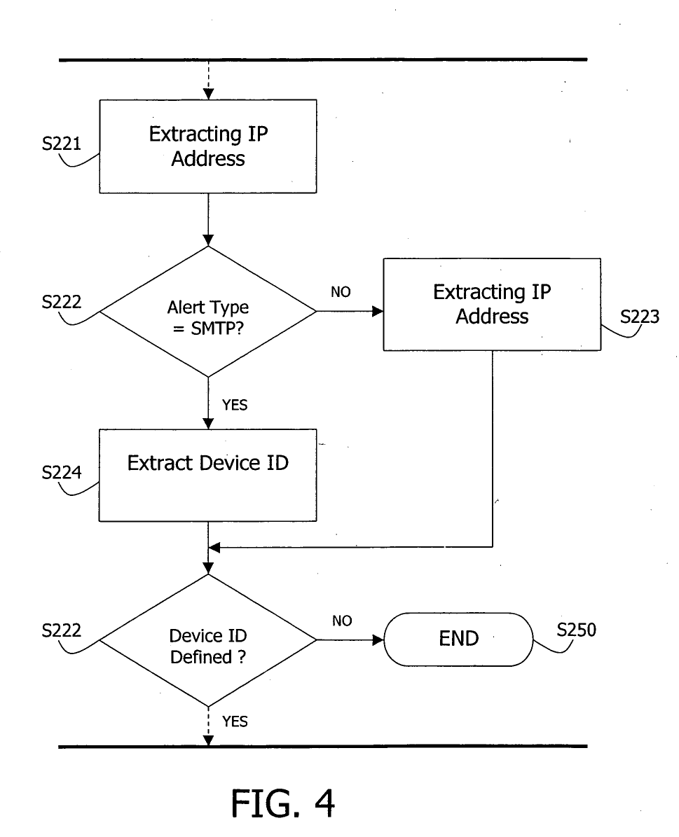

While validating the event source (step S220), the decoder module 180 discards the event alert 170 if the device ID is not found in the event alert 170. As the event alert 170 may be sent via different protocols, different method may be used for obtaining the device ID. An example of the event source validation (step S220) based on SMPT, SNMP, and SYSLOG is illustrated in FIG. 4.

Regardless of SMPT, SNMP or SYSLOG, an Internet Protocol (IP) address of the transmission source is extracted (step S221) directly from an event alert 170 by capturing a first parameter of the event alert 170. If the event alerts is a SMTP transmission (yes), the decoder 182 searches through the event alert for the device ID and extracts the device ID (step S224). Generally, the device ID is defined in a parameter enclosed by square brackets, for example. When the detected alert type is SNMP/SYSLOG (no) in step S223, the device ID has to be retrieved from a list of devices from a cache loaded in a storage module (step S223) (where is this storage module located, the NSSP side of the network side?).

From step S223 and S224, processing continues at step S226. If the device ID is not defined in the event alert 170 (step S226), the same may be discarded and the decoder terminates parsing (step S250).

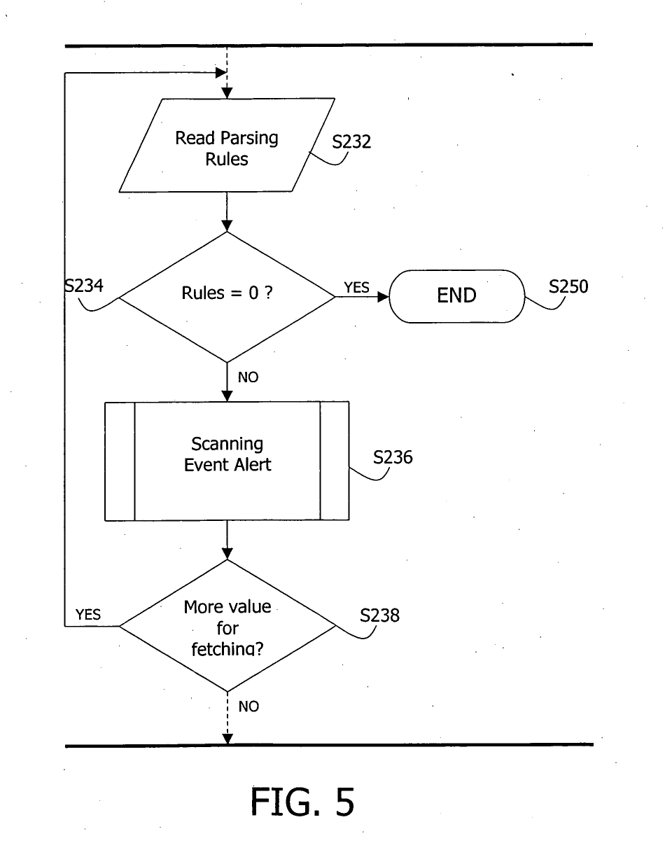

An example of operation of the event alerts 170 parsing process S230 of FIG. 3 is illustrated in FIG. 5. The decoder 180 reads parsing rules from the database 185 into a system memory, such as buffers (step S232). If no parsing rules is not found in the database 185, (yes) in step S234, the processing proceeds to step S250.

An instruction set among the database 185 is loaded based on the scanned alert type. The decoder 182 scans through the event alerts 170 and extracts all outputs based on the loaded instruction set (step S236). Each of the extracted outputs are assigned to a corresponding TIF field (step S238).

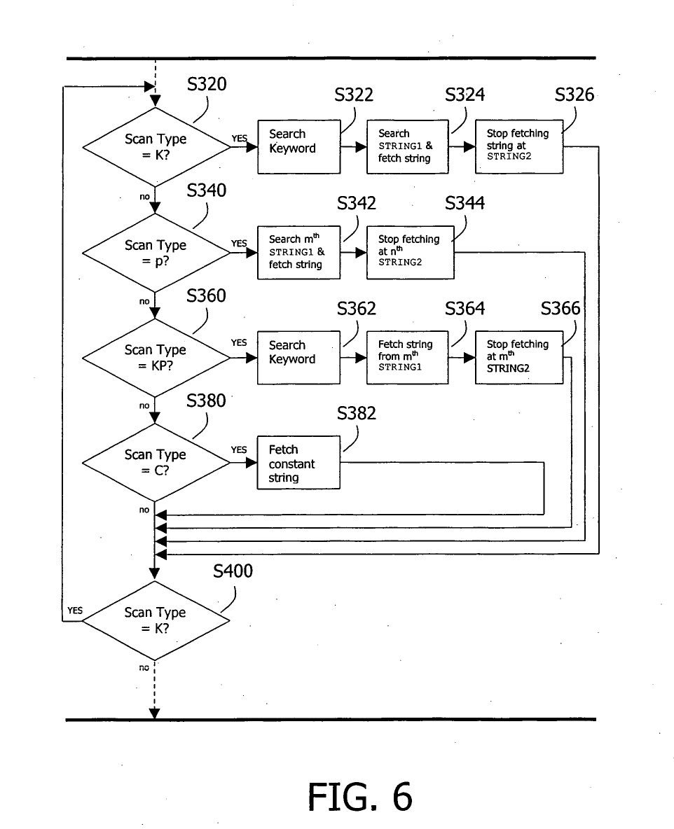

FIG. 6 illustrates operation of how the decoder module 180 parses an example of TABLE 3 based on a given extraction method and extraction syntax.

TABLE 3
An Example Of An Event Alert Received
By The Decoder Module

<166>Dec 04 2002 23:09:17: %PIX-6-1-06015:Deny TCP (no
connection) from 192.168.1.11/35952 to
198.128.105.1/35016 flags FIN ACK on interface outside

The decoder 182 will check which extraction method is defined in a syntax. If the extraction method is a keyword parsing (step 320), K, the syntax may have a format, <TIF Field>K<keyword><string1><string2>. The decoder 182 will locate the keyword from an event alert 170 as a start point of the string searches (step S322). The decoder 182 further locates the first occurrence of string1 and start fetches strings appears after the string1 (step S324). The string fetches will terminate once the first occurrence of the string2 appears (step S326). In case where string1 is not specified, the decoder 182 will returns the substring starting after the keyword right up to the position before string2.

Given a extraction syntax, TargetPort K “to” “/” “flags”, for example, will returns a substring “35016”.

If the extraction method is a position parsing (step S340), P, the syntax may have a format, <TIF Field>P<string1><number1><string2><number2>. The number1 and number2 specifies the specific number of occurrences of string1 and string2 respectively. The decoder 182 locates the number1 occurrence of string1 and fetches strings appears after the string1 (step S342) and stop fetching once the number2 occurrence of spring2 appears (step S344). In case where string1 is not specified, the decoder 182 will return the substring at the beginning right up to the position before string2.

Given an extraction syntax, SourcePort p “/” 1 “to” 1, for example, will return a substring “35952”.

If the extraction method is a keyword position parsing (step S360), KP, the syntax may have a format, <TIF field>KP<keyword><string1><number1><string2><number2>. The decoder 182 locates the keyword as a start point of searching (step S362), and fetches strings appears after the number1 occurrence of string1 after the keyword (step S364) and stop fetching once the number2 occurrence of spring2 appears (step S344). In case where string1 is not specified, the decoder module 180 will return the substring starting after the keyword right up to the position before string2.

Given a extraction syntax, TargetPort KP “from” “/” 2 “flags” 1, for example, will returns a substring “35016”.

If an output of a constant string is required for outputting (step S380), extraction method, C, may be used, <TIF field>C<constant string>. The decoder 182 fetches a constant string defined in the syntax (step 382).

When the decoder 182 is extracting a date and/or a time from a event alert 170, the format of the date and/or the time for outputting may be specified. Given an extraction syntax, AttackDate P “>” 1 “ ” 3<MMM DD CCYY>, for example, will returns “Dec. 4, 2002”.

When a substitution is needed to replace an extracted value, <value substitution> can be added to the parsing instruction. An example of a extraction syntax with the value substitution is Severity K “Priority:” “CRLF” {high=3, medium=2, low=1}, where is the extracted value is “high”, then the field of Severity will have an output of “3” and so on.

For the ease of parsing event alerts, the decoder 182 treated continuous spaces or tabs as a single space.

If a symbol “+” is used (step S400), step S320 to step S380 are repeated the for fetching another string based on the extraction method defined after “+”. Take for example an event alert given in TABLE 4:

TABLE 4
An Example Of An Event Alert

| | |
|---|---|
| Mar 24 12:10:56 test | ,Security,1114099,Mon |

Mar 24 12:10:25 2003,540,Security,SYSTEM,User,Success
Audit,test,,Successful Network Logon: User Name: test$
Domain: CISS Logon ID: (0x00x2DE2A70) Logon Type: 3
Logon Process: Kerberos Authentication Package: Kerberos
Workstation Name:

For an extraction syntax stated as below:

AttackType P “,” 11 “:” 5+C “Attempt”, where the first part of the syntax P “,” 11 “:” 5 returns a substring between the 11^{th} occurance of “,” and the 5^{th} occurance of “:”. The syntax also appends a constant string “Attempt” at the end of the substring. Hence, the resulting Attacktype for Example 3 is “Successful Network Logon Attempt”.

It will be understood by those skilled in the art that even though numerous characteristics and advantages of various preferred embodiments of the present invention have been set forth in the foregoing description, this disclosure is illustrative only. Other modifications may be made, especially in matters of structure, arrangement of parts and/or steps within the principles of the invention to the full extent indicated by the broad general meaning of the appended claims without departing from the scope of the invention.

1. A data decoding method for processing a log record of transaction in a computer system comprising the steps of:
loading an instruction set from a database;
extracting information from the log record based on a plurality of syntaxes defined in the instruction set; and
outputting a normalized output of an extracted information of the log record.

2. A data decoding method according to claim 1, wherein the data base comprising a plurality of the instruction sets, each of which prescribing a format information of the log record.

3. A data decoding method according to claim 1, further comprising the step of accessing the databased by a decoder.

4. A data decoding method according to claim 1, further comprising the setp of matching the log record with an instructions set.

5. A data decoding method according to any claim 1, further comprising the step of storing the normalized output.

6. A data decoding method according to claim 1, further comprising the step of receiving an information package having the log record from a transmission source remotes from the computer system.

7. A data decoding method according to claim 6, further comprising the step of identifying a device ID of the transmission source from the information package.

8. A data decoding method according to claim 6 or 7, further comprising the step of identifying a device ID of the transmission source from the information package.

9. A decoder module for processing a log record of transaction in a computer system comprising:
a decoder for outputting a normalized output; and
a database having a plurality of instruction sets accessible by the decoder, for which each of the instruction sets comprising a format information of the log record
wherein the decoder is operable to load one of the instruction sets matches the corresponding log record and to extract information base on a plurality of syntaxes defined in the matched instruction set.

10. A decoder module according to claim 9, wherein the normalized output comprising information extracted and normalized base on the plurality of syntaxes.

11. A decoder module according to claim 9, wherein one of the syntaxes further comprising a date formatting for outputting an obtained date in a prescribed format.

12. A decoder module according to claim 9, wherein one of the syntaxes further comprising a time formatting for outputting an obtained time in a prescribed format.

13. A decoder module according to claim 9, wherein the log record is received from a transmission source remote from the computer system.

14. A decoder module according to claim 13, wherein the transmission transmits an information package having the log record.

15. An information processing system comprising:
an information processing unit;
a memory in response to the information processing unit for processing information;
a decoder module installed in the information processing system for outputting a normalized output;
a database having a plurality of instruction sets accessible by the decoder, for which each of the instruction sets comprising a format information of the log record
wherein the decoder is operable to load one of the instruction sets matches the corresponding log record and to extract information base on a plurality of syntaxes defined in the matched instruction set.

16. An information processing system according to claim 15, further comprising a data depository unit for storing the normalized output.

17. An information processing system according to claim 15, wherein the normalized output comprising information extracted and normalized base on the plurality of syntaxes.

18. An information processing system according to any claim 15, wherein one of the syntaxes further comprising a date formatting for outputting an obtained date in a prescribed format.

19. An information processing system according to any claim 15, wherein one of the syntaxes further comprising a time formatting for outputting an obtained time in a prescribed format.

20. An information processing system according to any claim 15, wherein the log record is received from a transmission source remote from the computer system.

21. An information processing system according to any claim 15, wherein the transmission transmits an information package having the log record.
